(19) United States
(12) Patent Application Publication
(10) Pub. No.: US 2006/0041468 A1
(43) Pub. Date: Feb. 23, 2006

(54) Custom printed, voter verified ballots with fixed range input

(76) Inventor: David C. Reardon, St. Charles, MO (US)

Correspondence Address: David C. Reardon, 29 Olde Westchester Court, St. Charles, MO, 63304, US

(21) Appl. No.: 11/256,421

(22) Filed: Oct. 21, 2005

Related U.S. Application Data
(63) Continuation-in-part of application No. 10/013,277, filed on Dec. 12, 2001, now Pat. No. 6,968,999.
(60) Provisional application No. 60/258,346, filed on Dec. 28, 2000.

(51) Int. Cl. G06F 11/00

(52) U.S. Cl. 705/12

(57) ABSTRACT

An apparatus and method for creating a voter verified printed record of votes cast by each voter during an election. The printed record normally includes only the names of the candidates for whom the voter has voted in a form that is easily readable by both humans and machine. This unambiguous printed ballot makes it easy for a voter to verify the accuracy of his or her intended vote and can subsequently be used to cast the voter's official vote or saved to provide an audit trail for subsequent confirmation of the electronic tally. Moreover, techniques are provided to minimize or eliminate the need for reprogramming of the electronic equipment prior to each election using one or more fixed range inputs that are electronically mapped to voting options available for each election.

The present application is related to and based on Provisional Patent Application Ser. No. 60/258,346 filed Dec. 28, 2000 entitled “A Computer Enhanced Voting System Including Verifiable, Custom Printed Ballots Imprinted to the Specifications of Each Voter” and patent application Ser. No. 10/013,277 filed Dec. 12, 2001 on which priority is herewith claimed under 35 U.S.C. § 119(e) and the disclosure of which is incorporated herein by reference in its entirety.

### BACKGROUND OF THE INVENTION

1. Field of the Invention

This invention relates generally to electronic voting systems and, more particularly, to the means of selecting and recording votes in a manner that minimizes or eliminates the need for reprogramming of the electronic equipment prior to each election and will, after selections have been made, produce a voter verifiable printed record of the selections made.

2. Description of the Prior Art

This invention relates in general to electronic voting systems and more specifically to a voting system that provides for the printing of customized ballots at the time a voter casts his or her ballot.

The presidential election of 2000 illustrated the hazards of punch card ballots and the uncertainty of verifying voter intent. Indeed, since punch card ballots are not easily read by voters, there were many voters who subsequently felt disenfranchised based on the fear that their intended vote was not accurately recorded.

This national controversy revealed that there is the need for a method to cast ballots that is (1) easy for humans to read, so that both voters and election officials can verify the accuracy of the cast vote, (2) easy for machines to read for the purpose of automating the count, and (3) provides for multiple paths of verification. In addition, the ideal voting system must be inexpensive, easy to prepare for each election, and easy to setup at voting locations.

At one time, “Votomatic” punch cards were the nation's most commonly used means for recording voter's selections. Following the presidential election of 2000, however, this method of voting has become disfavored. There is a major drive in some quarters to move toward computer aided touch screen voting and adoption of “direct recording electronic” (DRE) voting systems.

The problem with electronic voting systems is that many people worry about the risk of a conspiracy to change, or misreport votes within the “black box” of the electronic voting system. Therefore, as described in related patent application Ser. No. 10/013,277, DRE systems should be augmented with the simultaneous printing of a voter verified paper record. While DRE systems are extremely useful for generating immediate results at the end of the voting day, a voter verified paper record that can also be read by election officials, or scanned, following the election, provides a mechanism to ensure that the reported electronic tally matches the tally that can be subsequently generated using the voter verified paper records.

Another difficulty with DRE systems, and especially touch screen voting systems, is that such a system requires at least a modest level of reprogramming with each election to change the names of candidates, number of candidates in each race, and other skip criteria. Any reprogramming at all, however, requires that election officials must retest the equipment and examine the software to ensure that there are no “back-doors” being added which provide a means of election fraud. In addition, as the present invention shows, touch screens are unnecessarily expensive input devices for collecting an electronic record of votes.

The present invention, teaches a more cost effective techniques for inputting voter's selections that minimizes or eliminates the need for reprogramming, thereby reducing the costs of setting up and verifying equipment and increasing voters' confidence in the election process.

### Glossary

The following glossary of technical terms used repeatedly throughout this disclosure will be of substantial benefit for the reader to understand the invention:

Ballot refers to the list of voting options presented to a voter.

Ballot map refers to the mapping of each ballot-specific voting option to one the fixed range of input codes.

Input codes refer to the predetermined, finite number of input options, or “fixed input codes,” that can be recognized by the electronic input device used to make voting selections. The input codes are not specific to a particular election or ballot but are instead reusable for an unlimited number of elections since each code may be associated with the different voting options unique for each election.

Intermediary paper record is a printed record identifying the voters selections in an encrypted form such that the voter's selections are not readily readable by the voter and election officials but must be interpreted by a device that produces the human readable paper record.

Paper record is the printed record identifying the voter's selections in an unambiguous form that is readable by the voter and election officials. The word “paper” is used to describe the preferred substrate for printing a tangible record of the voter's selections, but is not meant to exclude the use of other materials, such as plastic substrates, that would serve an equivalent function.

Selections or voting selections refer to the voting options selected by the voter.

Voting options include all possible options on a ballot. This can include candidate's names grouped under a contested office, “yes” or “no” in regard to propositions, and other options such as “write in,” “void all selections,” or any other option that may be useful.

Vote casting unit refers to an electronic device which accumulates an electronic tally of the selected votes after the voter has verified the accuracy of the printed record of the selected voting options. The functions of the vote casting unit may be integrated into the vote selection device, or in some embodiments, separated from the vote selection device.

Vote selection device refers to the electronic device which allows the voter to make selections from the ballot.

It was in light of the foregoing that the present invention was conceived and has now been reduced to practice.

### SUMMARY OF THE INVENTION

The present invention describes multiple ways for creating a voter verified printed record of votes cast by each voter during an election. The printed record normally includes only the names of the candidates for whom the voter has voted in a form that is easily readable by both humans and machine. This unambiguous printed ballot makes it easy for voters to verify the accuracy of their intended vote and can subsequently be used to cast the voter's official vote or saved to provide an audit trail for subsequent confirmation of an electronic tally of the votes that is created at the time voting options are selected or cast.

Moreover, the invention provides techniques to minimize or eliminate the need for reprogramming of the electronic equipment prior to each election by using one or more fixed range inputs that are electronically mapped to voting options available for each election. By restricting the vote selection device to be permanently responsive to a fixed range of input codes, the reprogramming of the vote selection device for each election may be minimized or eliminated. Restricting the programming in this way precludes any opportunity for tampering of the election equipment's programming. Instead of reprogramming the device prior to each election, election officials need only to create a ballot map that represents the assignment of each available voting option to one of the fixed input codes. For example, to mimic the familiar “Votomatic” system, booklets would be printed with each voting option corresponding to a “punch hole” associated with each of the fixed input codes Instead of punching a card, however, placing the input wand into the selected hole would trigger an electronic response that would include (1) sensible feedback to the voter that the selection was identified, for example, with a audible buzz or light flash, or both, and (2) an electronic recording of the vote. The process is then completed by printing a human readable paper record that allows the voter to verify that the electronically recorded vote corresponds to the voter's intent.

### BRIEF DESCRIPTION OF THE DRAWINGS

The foregoing aspects and other features of the present invention are explained in the following description, taken in connection with the accompanying drawings, wherein:

FIG. 1 is a block diagram of the pertinent components of the electronic input device by which the voter would make his selections.

FIG. 2 is an example of a paper record printed after the voter has made his selections which allows the voter to verify his selections and provides a basis for election judges to compare the electronic tally with all the paper records representing an auditable record of the voters' selections.

FIG. 3 illustrates an intermediary paper record of the voter's selections that may be used in some embodiments to minimize the use of cables and other hardware at the election site.

FIGS. 4 and 4A illustrate the relationship between the vote selection device in the voting booth and the optional vote casting unit that would typically be located at the judges' table.

FIG. 5 is a block diagram of the pertinent components of the optional vote casting unit.

### DESCRIPTION OF THE BASIC EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Referring now to FIG. 1, the vote selection device includes a basic computing device 10, perhaps a standard computer, that is preprogrammed with a list of all the possible votes that can be cast on that voting day for that particular precinct. It is connected to a voter operated input device, the selection entry means 18, and a printer 11 by which the voter's ballot will be printed once the voter's selections are completed.

The interconnection between the precinct computing unit, the selection entry device, and the printer can be in any of many configurations that will be obvious to those skilled in the art. Alternatively, the selection entry device and the printer could be arranged as a single unit of which several could then be placed into individual private voting booths that are networked to the precinct computing unit. Alternatively, each voting booth might have only the selection entry device but the printer would be located at the voting judges' table. Any of a number of similar configurations could be provided Similarly, the selection entry means 11 can be one of many well known devices, for example, a numeric keypad, an alphanumeric keyboard, a touch screen, a bar code reader or similar scanning device. Through these expedients, the voter may either enter individual selections or may enter the code for a pre-selected slate of votes.

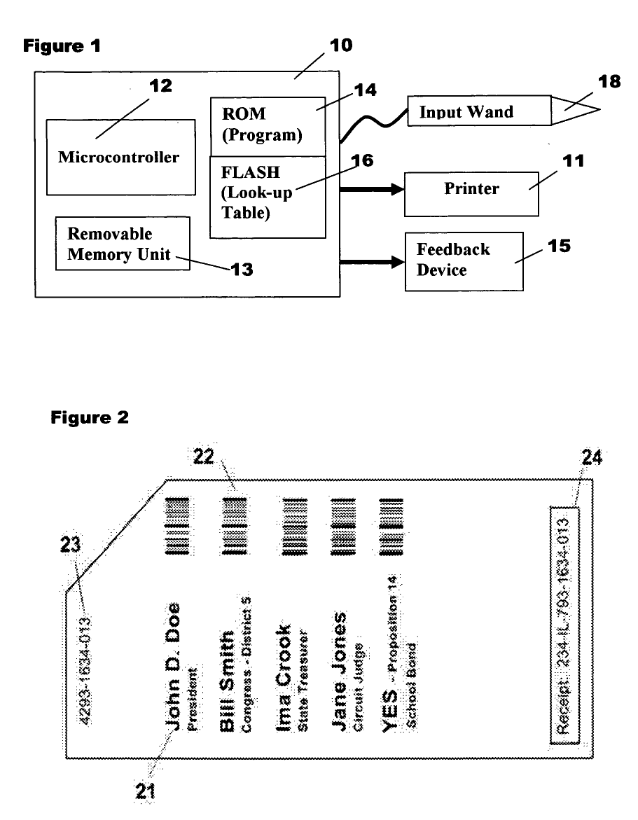

In traditional voting scenarios, completed ballots appear identical to each other except for the different markings voters have placed on the ballots. The key innovation in this invention, however, is that after a voter has made his selections with an electronic input device, a paper record of the votes selected is created. FIG. 2 illustrates a typical embodiment of a custom printed ballot. In this example, only the names of the candidates actually selected by the voter 21 are printed on the ballot. Competing, but non-selected candidates names are omitted. This makes it easy for the voter to verify the accuracy of the ballot with a quick glance at the printed list of names. Typically, the names would be printed in larger bolder letters with the office being filled printed in smaller letters beneath the name. For referenda, a proposition number would be printed with “YES” or “NO” clearly indicated. Alternatively, if state law required all candidates names to be on the paper records retained from the election, the selected name and unselected names could be printed in a different fonts, with the selected names, for example, in a large bold font and the unselected names in a relatively inconspicuous font. In this way, the selected voting options are unambiguously displayed in the printed record for easy verification by the voter and election officials.

The printing of the ballot may also include two additional options. First, to facilitate machine reading of the ballot, a unique bar code or other machine readable code 22 unique to each candidate or vote might also be printed at an appropriate place on the ballot. Another option would include printing a unique ballot identification number on the ballot 23 as well as upon a suitable receipt 24 to be given to the voter. In FIG. 2, the receipt 24 is indicated to be in the form of a peel off label affixed to the ballot that can be easily removed and given to the voter. A perforated, tear off, receipt might also be conveniently used, or separate receipt might be printed on a second ballot clearly marked as a receipt and lacking the machine readable codes, so as to prevent it from being used to cast an additional vote. By whichever of the many forms which could be used for printing a receipt, this receipt may subsequently be used by the voter, as described elsewhere, to confirm that the votes were properly tallied in the final count or in an investigation of vote tampering.

Using an appropriate scanning machine, the printed ballots can subsequently be tallied in a rapid and consistent manner. In the event that the bar code is unreadable, either an optical character recognition scanner may be employed to read the printed names or the ballot may be automatically segregated for examination by election officials.

In a typical application, the count of the printed ballots would be used for the final certified results since the printed ballots have more evidentiary value than a purely electronic tally that may be subject to software glitches, data loss, computer hacking, black outs, fraudulent reporting or other errors that undermine voter confidence. On the other hand, a purely electronic tally of the cast votes can also be easily generated by one or both of the following means.

By establishing a communication link between the vote selection devices at the precinct level and computers at the state, or federal headquarters all votes cast at the precinct level may be transmitted to the central headquarters either in real time or after the polls close. Also, or alternatively, an electronic record of all the cast votes, or a tally of all votes cast for each candidate, may be stored on a removable memory unit 13. The removable media might be, for example, be a nonvolatile FLASH memory device, magnetic media, or optical disk written to by the control unit. In the preferred embodiment, the electronic data be encrypted with an asynchronous key unique to the precinct computing unit so as to provide additional electronic evidence that the file was created by the precinct unit. In any event, when the voting booths are closed, the electronic data can be transported to the county's vote commission, for example. At the county level, in this example, all the electronic records from the many precincts could be downloaded into a central computer and instantly tabulated. The results of this count would then be subject to verification by a hand or machine count of the voter verified printed records.

### Detailed Description of a Preferred Embodiment

In a preferred embodiment, voting booths 44 originally equipped to use punch cards and printed booklets displaying the all voting options would be retrofitted to include a vote selection device 46. Details of the vote selection device 46 are shown in FIG. 5, which in block diagram form shows that the vote selection device the would typically include a battery operated electronic control unit 10 and an electronic input device 18 which, in this example, is a barcode reading wand. The electronic control unit would include a microcontroller 12 and a program stored in read only memory 14. The use of read only memory, perhaps embedded in the microcontroller itself, precludes any tampering with the program and reduces the need for exhaustive testing of the equipment before each election. Alternatively, the electronic control circuit could be comprised of any logic circuitry, such as an application specific integrated circuit (ASIC), capable of the basic sensing and recording of results described below. In either example, the programming would be such that the microcontroller 12 would recognize only a fixed range of inputs from the input device 18 and would also be programmed to treat each of the fixed range of inputs in a predefined fashion.

The concept of a fixed range of inputs is further clarified by the following discussion. Various input devices, such as keyboards or scanners, have the ability to transform a limited number of inputs (keys on a keyboard, or black versus white spaces, respectively) into an infinite variety of input codes (keystroke combinations or dot patterns, respectively). In this invention, however, the programming of the electronic vote selection equipment is designed to recognize only a fixed range of input codes. The fixed input codes might be predetermined bar codes, predetermined positions on an electronic or pressure sensitive grid or screen, or pre-specified keyboard entered codes (excluding the keyboard entry of indeterminate words or names), or other similar input devices Because this range of fixed inputs does not need to change with each election, according to this invention, the number of input codes that the vote selection device would need to be programmed to process would be numbered in the low hundreds. It is useful to describe this fixed range of input codes as sequential numbers, for example, a range from 1 to 256.

Prior to each election, election officials would print the appropriate voting pages, as has always been done with Votomatic voting booths, but instead of associating each option with a numbered punch hole, each option would be associated with a simple bar code printed along side the name. For example, position 1 would be replaced with the barcode equivalents of 001001001 and position 256 would be replaced with the barcode equivalent for 256256256. To avoid printer errors, the booklets might consist of a clear plastic pages permanently imprinted with the barcodes and the printed pages would slip between the plastic sheet so that the names would fit behind the corresponding bar code. One of the advantages of this system is that it replicates a familiar task of election judges: inserting new pages in the voting booklets used with Votomatic booths.

In the preferred embodiment, upon arriving at the precinct, verified voters would be given a blank card that would be inserted into a small, possibly battery operated, printer 11 that is connected to the vote selection device mounted in each voting booth. The printer 11 and electronic control unit 10 might well be contained in the same case with the input wand 18 connected to the case by a cord. The cord would not only contain wires to transmit readings to the control unit but would also act as a tether to prevent voters from walking off with the input wand. Upon entering the voter's booth, the voter would insert the blank card into printer. Optionally, a sensor in the printer might recognize that the card is inserted and transmit this “card inserted” signal to the control unit which might then display instructions to the voter, if some type of display is also included in the control unit.

To make the selection, the voter would simply swipe the wand across the bar code corresponding to the chosen option. Preferably, at least one electronically controlled feedback device 15 would be included to provide sensory feedback, a flashing light or buzz, that would confirm for the voter that the entry was recognized. If the voter wanted to cancel the selection, each page might include an additional bar code, for example, at the bottom of each page, that could be used to cancel the selection and reenter a selection.

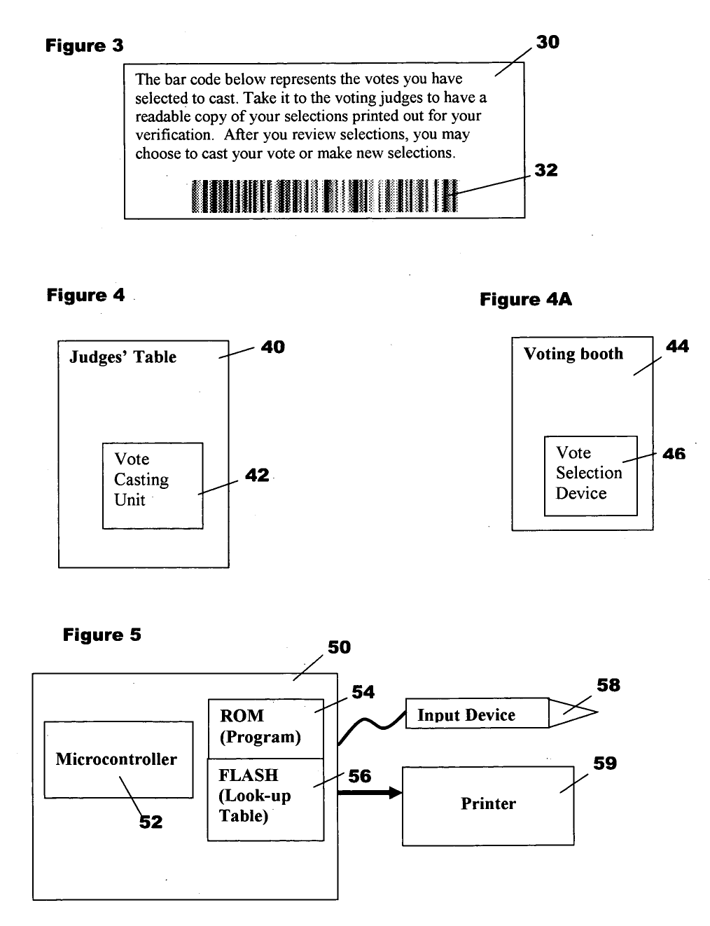

In the preferred embodiment, the voter would also be presented with a bar code, perhaps printed at the end of the booklet, and also on a sticker mounted to the voting booth, that indicates that the voter has completed all of his selections. Upon swiping this bar code, the printer would use the blank card provided to the voter by the election officials to print, as seen in FIG. 3, an intermediary record of the voter's selection 30 which represents the combined results of all selections printed in an encoded form, such as another barcode 32.

The voter would take this intermediary record 30 back to the election judges' table 40. At the judges' table, or in a special verification booth located near the judges' table, there would be a vote casting unit 42. As shown in FIG. 5, the vote casting unit might be very similar to the vote selection device, including an electronic control unit 50, an input device 58 and a printer 59. In this embodiment, the input device 58 would be a barcode reader and the intermediary record 30 would be scanned at the vote casting unit. At this point, an electronic record of the pending votes would be captured by the vote casting unit and a the voter verified paper record 22, shown in FIG. 2, would be printed out. If desired, this could occur in or near a separate screened booth wherein the voter could freely examine the printed paper record without concern that others would be looking at the paper record of his votes.

Once the voter decided that the paper record 22 was correct, the paper record might be placed into a ballot box and the judges, or voter, would use an input device 58 to indicate to the vote casting unit, that any votes temporarily stored in memory 55 should be added to the electronic tally of all votes cast that day, or alternatively, a complete electronic record of each vote cast could be maintained. This electronic tally, or complete record, would be stored as previously discussed and can subsequently be compared to the paper records deposited into the ballot box, which should match, of course. If the voter indicated that the paper record was inaccurate in any way, the judges or voter could use the input device 58 to indicate rejection of the selected options and the votes temporarily stored in memory would not be added to the running tally. Optionally, the voided paper record 22 and the intermediate record 30 could be inserted in the printer to receive a printing of void across the back or front of the records and deposited in the ballot box, or preferably, in a voided ballot box, in order to keep every paper record, even those voided, in the custody of election officials.

To further reduce costs, the printer 11 in each vote selection booth can be omitted and replaced with another feedback device 15 controlled by the control unit 10. In this alternative embodiment, the feedback device 15 might be a small electronic display. When the voter indicates that he has completed his selections, a binary encoded equivalent of the selections would be converted into, for example, a six character alphanumeric code. This code could also include a checksum and encryption code such that even identical selections would produce a wide variety of different six digit codes. This may be useful to discourage vote selling by eliminating the ability to “prove” that one's code matched a desired setting. The voter would then simply write down this six digit code on a pad provided in the booth and carry the code over to the judges table. The code could then provided to the vote casting unit by keypad, at which point the code would be decoded to identify all the selections and electronic recording of the votes and printing of the paper record 22 would proceed as described above. This embodiment reduces only the cost, power load requirement, and maintenance issue costs related to having a printer in each voting selection booth, since small six-digit alphanumeric LED and LCD displays are very inexpensive, reliable, and energy efficient.

Alternatively, if printers are in place in each voting selection booth, the intermediary record 30 could be omitted and instead the voter verifiable paper record 22 could be printed at each vote selection booth. In this alternative embodiment, each control unit 10 would require the information necessary to translate the fixed input entries into a human readable form of the voters selection. This would most conveniently be done by providing non-volatile, reprogrammable memory, such as nonvolatile FLASH memory 16, in each control unit. Prior to each election, the FLASH memory would be programmed with a one-to-one mapping of each selection, for example “John D. Doe,” with the fixed input option corresponding to that name in the printed voter's selection booklet. Using this ballot map, which those skilled in the computer arts will recognize as a lookup table, the control unit would print the name or selection assigned to the bar code that the user actually scanned. This would allow the voter to immediately verify that the printed response matched his selection. This is advantageous, but it has several draw backs in comparison to the preferred embodiment described above. First, the FLASH memory unit in each control unit must be programmed before each election, which requires time and verification. Second, in this alternative embodiment, it would seem most reasonable to collect an electronic tally of the votes within the each control unit when the record is printed and verified by the voter, while still within the voting booth. This presents the slight additional problem that the results must then be collected from each control unit. This may create additional costs, especially if the units are networked, by wire, radio frequency, or optical links, to a central computer that gathers all the data. It also presents the additional risk that the electronic record of votes cast in a particular booth could be lost if the unit fails or is vandalized.

By contrast, with the preferred embodiment, each voting booth is autonomous and has no critical data functions. As long as the pages in the voting book are correct, the correct result code will be printed.

In the preferred embodiment, the voter's selections are electronically “transcribed” by the control unit and printer in the each voting booth but are not “entered” into the electronic record until transferred, by the voter's hand, to the vote casting unit at the judges' table.

It is to be understood that the foregoing general description and the following detailed descriptions are exemplary and explanatory but are not to be restrictive of the invention.

### Various Additional Embodiments of the Invention

The present invention may be implemented in many other ways. Additionally, minor variations of the invention may be implemented to achieve particular advantages.

For example, in the preferred embodiment described above, bar codes are printed in the voting booklet attached to the modified Votomatic booth. Alternatively, the area where the punch card would otherwise be placed can be replaced with a position sensing device, which may be a pressure sensitive pad or a grid of conductive paths that can be used to sense where the input wand is touched. This sensor would not be removed, but would remain in place for each voter. As with the Votomatic system, each turn of the ballot page would expose an additional column of holes through which the voter would make his selection. Instead of pressing out paper chads, however, the act of inserting the input wand through the hole would result in an electronic sensing of which selection is being made. In this case, the control unit might sense the pressure sensitive pad or grid instead of the input wand. If the input pad were pressure sensitive, the input wand would merely be a stylus for applying pressure to the fixed access points exposed by the holes over the grid. Alternatively, if the grid were composed of electronic sensors, the input wand might be an electronically grounded point used to complete an electric circuit associated that would be detected by the control unit to identify which fixed point was touched. The means of implementing any of these alternatives will be immediately obvious to those skilled in electronics.

Alternatively, the precinct ballot booklet could be eliminated by printing the entire ballot onto a single large sheet, which would be placed over a pressure sensitive grid, with both the ballot and grid then covered with a clear plastic sheet. The printed ballot would be printed in a fashion that aligns each option with the known coordinates associated with a fixed input on the pressure sensitive pad. Instead of reading a input wand, the electronic control unit would read the position or pressure sensitive pad whenever a voter pressed on a voting option aligned over the predetermined grid points. A number of control points could also be provided to indicate, for example, that the voter is finished with his selections, wishes to void the ballot, or wishes to have the printer print a space for a write in vote for any particular race.

If desired, a small electronic display controlled by the control unit could be used to display the selected options prior to printing. If each unit were programmed with a look-up table, the display could display the name of the selected candidate, otherwise it might display only the number associated with the selection which would also be visible on the selection ballot. If a display was used, it is most likely that the printing of the voter's selections on the paper record 22 would take place after the voter had indicated that he was done with all of his selections. It could also display notices such as “Two entries may not be made. Please reenter your selection.” After the voter indicates that he has completed making his selections, the display might also notify the voter of any contests for which the voter did not make a selection and present him with the option of going back to make selections in those races. Including the optional display would also provide a method of notifying a voter of any options. For example, a set of unique codes could be set aside for instances where a voter is allowed more than one vote in a category, for example the option to vote for up to three candidates. In some jurisdictions, voting for only one of three candidates means the voter gives all three votes to the one candidate. In other cases, it may count as only one vote and the voter missed the chance to vote for two additional candidates. In any event, unique fixed input codes could be associated with multiple vote entries and the control unit could keep track of how many votes have been cast in such cases. For example, after selecting the first of three potential votes, the display could read “You have made one vote in this race. You are allowed to make up to three.” After the second vote, it could read, “You have made two votes in this race. You are allowed to make up to three.” The above is merely illustrative of the fact that the control unit can be preprogrammed to respond to range of fixed inputs that generate a variety of responses and voter feedback appropriate to governing rules of any election.

Another variation on the invention might be employed to reduce the number of printers required at each precinct. In this variation, a printer would not be required for each voting booth. Instead, all the records of the voter's selections would be printed at the judges' table, in a fashion that would prevent the judges from seeing the votes cast while still allowing the voter to verify the accuracy of the printed record. In this variation, there would in essence be two different types of booths, vote selection booths and a single vote casting booth positioned near the judges table. The vote selection booths would contain, at a minimum, the control unit 10 and the selection and input device 18. In this arrangement, the selections made in the vote selection booth would proceed as described above, but the printing of the voter verifiable record and the casting of the votes is done elsewhere, at the vote casting booth. The vote casting booth, which may or may not include screening walls, would contain an electronic control unit and printer for converting an input of the vote selections into a voter verifiable record that can be cast or voided at the vote casting booth. Several methods of transferring the information describing the vote selections, electronically or manually, to the vote casting booth are described below.

First, the vote selections made at each of several vote selection booths could be transmitted to the control unit at the vote casting booth by wire, a radio frequency, or with an infrared or optic transmitter and receiver. The latter might be most desirable, since cabling always involves an obstruction and radio frequencies are easily jammed. As several voters may be simultaneously making selections, it is necessary to match each voter, when he or she comes to the vote casting booth, with his or her own selections. To facilitate this process, each voter could be given a reusable numbered card before going to a vote selection booth. For the purpose of this example, let us assume there are ten numbered cards. The voter would go to the booth and use the input wand to scan a code on the numbered card that effectively means “begin recording the selections for the holder of card 9.” These selections would be transmitted from the control unit for the selection booth to the control unit for the vote casting booth. When the voter is done making his selections, it would be convenient to end his selection process by scanning a second code on the card effectively representing “the holder of card 9 is done making selections.” At this point the voter returns to the judges' table only with the numbered card. An intermediary voting record 30 is not used, of course, since there is no printer in the voting booth. Instead, the voting selections have been transmitted to a central control unit at the judges' table and stored in temporary memory. Upon presenting the voting card back to the election officials, it is scanned by the central control unit and matched to the votes held in temporary memory and these results are printed onto a paper record for the voter to verify. If verified, the votes are of course finalized in the tally and the paper record is placed into the ballot box. The numbered card can then be reissued to another voter. By using these reusable numbered cards, multiple voters can be properly matched to their voting selections even if they return to the judges' table in a different order than the issued cards. The primary advantage of this process are that only one printer is required.

As described in the preferred embodiment, the judges would hand a blank card to each voter, which would then be used for printing an intermediary record 30 or the final paper record 22 in the voting booth. Alternatively, the printers in each booth could be equipped with just a roll of paper, such as is commonly used in cashier or gas pump printers. The advantage of having a judge issue a blank card is that this provides judges with an opportunity for initialing the card before it is printed. They can then check the initial when it is returned by the voter to better keep track of every piece of paper involved in the voting process. Another advantage in using a heavier, perhaps card stock, material similar to the punch cards used in Votomatic systems is that such heavier material for paper records is more easily stacked and aligned for automated scanning. In the preferred embodiment, all records would be scanned within a day or two of the election so the complete scanned results could be compared to the electronic tally.

Additional modifications of the invention might be readily made to serve the needs of disabled persons. For example, voting options might be printed in Braille alongside the fixed barcode or other fixed input. Alternatively, a menu driven audio recording, delivered through headphones, could present voting options to the voter in any number of languages. In this latter embodiment, the options would be mapped to input codes associated to the voting options presented either in a time based response or a fixed key response. As an example of the former, for example, the recording might list the names of the candidates and then give a slow listing of the names and instruct the voter to “Press the button now if you wish to vote for John Doe.” If the button was pressed within two seconds, the vote would be recorded for John Doe, otherwise the message would proceed to the next option. Or if a keypad numbered with Braille is provided, the voter could be instructed to “Press 1 to vote for John Doe. Press 2 to vote for Jim Smith. Press 3 to Repeat the options.” In any event, after the vote is input, the programming could repeat the name associated with the input code and present the voter with the option to change his or her vote by pressing another key.

Although the description above contains many embodiments and precise examples, these should not be construed as limiting the scope of the invention but merely provide illustrations of some of the principle ways in which the invention can be implemented. Once disclosed, customizing this process to suit the individual needs or requirements of voting officials will be obvious to one skilled in the art. Thus, the foregoing is considered as illustrative of the principles of the invention, but is not by any means exhaustive. Numerous modifications and changes will be obvious to those skilled in the art.

What is claimed is:

1. A voting method enabling verification by voters of their votes cast during an election comprising the steps of:
(a) providing at a voting location at least one computing unit that is responsive to a fixed range of input codes from an electronic input device, at least one printer device, and a ballot listing all voting options;
(b) assigning a first voting option to a first input code and a second voting option to a second input code;
(c) permitting each voter to use an electronic input device to select at least one voting option;
(d) upon determining that the voter has selected the first voting option using the printer device to print a record of the vote cast for the first voting option in indicia readable by the voter, election judges, and automated scanners;
(e) upon determining that the voter has selected the second voting option using the printer device to print a record of the vote cast for the second voting option in the indicia that is readable by the voter, election judges, and automated scanners; and
(f) offering the voter an opportunity to read and verify the accuracy of the printed record.

2. The voting method as set forth in claim 1 including the steps, before step (c), of:
(g) providing that the equipment of step (a) comprises a first computing unit responsive to a fixed range of input codes from a first electronic input device and a first printer device, the combination being used as a vote selection unit, and a second computing unit responsive to a fixed range of input codes from a second electronic input device and a second printer, the combination being used as a vote casting unit;
(h) using the first electronic input device in step (c); and including the steps, after step (c) and before step (d), of:
(i) using the first printer device to print an intermediary record of the selected input codes in an encoded format that is not readily readable by the voter or election officials;
(j) using the second electronic input device to decode the intermediary record; and
(k) using the second printer to print the record required in steps (d) and (e).

3. The voting method as set forth in claim 1 including the steps, before step (c), of:
(g) providing that the equipment of step (a) comprises a first computing unit responsive to a fixed range of input codes from a first electronic input device, the combination being used as a vote selection unit, and a second computing unit responsive to a fixed range of input codes from a second electronic input device being of a keyboard type, the combination being used as a vote casting unit and the printer being responsive to the vote selection unit;
(h) providing an electronic display that is responsive to the first computing unit;
(i) using the first electronic input device in step (c); and
including the steps, after step (c) and before step (d), of:
(j) using the electronic display to display an intermediary code that represents all the information necessary to decode all the selected input codes;
(k) requiring entry of the intermediary code on the keyboard at the vote casting unit; and
(l) using the vote casting unit to decode the intermediary code in order to retrieve all of the selected input codes.

4. The voting method as set forth in claim 1 including the steps of:
(g) providing a voter viewable display controlled by the computing unit connected to the electronic input device used by the voter to select voting options; and
(h) providing programming for the computing unit to display predetermined messages on the voter viewable display whenever input codes within a predetermined range are selected.

5. The voting method as set forth in claim 1 including the steps of:
(g) providing a voter viewable display controlled by the computing unit connected to the electronic input device used by the voter to select voting options; and
(h) programming the computing unit to display predetermined messages on the voter viewable display whenever the predetermined program rules associated with a fixed range of input codes are met.

6. The voting method as set forth in claim 1 including wherein the electronic input device is a bar code reader and the input codes are bar codes.

7. The voting method as set forth in claim 1
wherein the electronic input device is a position sensing device; and
wherein the input codes are inputs associated with preselected positions on the position sensing surface.

8. The voting method as set forth in claim 1 wherein the
electronic input devices are a position sensitive device and the input codes are inputs associated with fixed positions, the printer is a thermal printer, and the indicia is text printed in a sans font.

9. The voting method as set forth in claim 1 including the steps, before step (b), of:
(g) playing an audio recording that presents the voting options in a manner that allows each voting option to be associated with an input code; and
including the steps of:
(h) after step (d), presenting an audio recording identifying the first voting option; and
(i) after step (e), presenting an audio recording identifying the second voting option.

10. The voting method set forth in 9 including the step of:
(j) allowing the voter to select the language in which the audio recording will be played.

11. A voter verifiable voting system for recording votes cast during an election that has a plurality of voting choices to select between, comprising:
a computing unit with program instructions and electronic memory;
an input device operatively connected to the computing for a voter to select one of the plurality of voting;
a printer device responsive to the computing unit to print indicia that is indicative of the selected one of the plurality of voting choices in a manner creating a tangible record, the printed indicia comprising text, the text having a configuration that is dependent upon the selected one of the voting choices; and
a record keeping container in which the voter verifiable records are deposited after the voter has had an opportunity to view the record and to verify therefrom that the text of the indicia is indicative of the voter's selected choices.

12. The voter verifiable voting system of claim 11 wherein
the computing unit stores an electronic record of all votes cast.

13. The voter verifiable voting system of claim 11 wherein
the computing unit stores an electronic tally of all votes cast for each voting choice.

14. The voter verifiable voting system of claim 13 wherein
the computing unit is an application specific integrated circuit, the input device is a bar code reader, and the electronic tally is stored in removable nonvolatile electronic memory.

15. A voter verifiable voting system for recording votes cast during an election, comprising:
a vote selection unit including:
a computing unit with program instructions and electronic memory;
an input device for a voter to input voting options; and
an output device to output a code generated by the computing unit wherein the code represents all the voting options selected by the voter in a format such that the selected options are not readable by the voter or election officials; and
a vote casting unit including;
an input device for inputting the code outputted by the vote selection unit;
a computing unit with program instructions and electronic memory operable to identify from the code all the voting options selected by the voter;
a printer for printing a voter verifiable record of the voting options selected by the voter in a font that is readable by the voter; and
a record keeping container in which the voter verifiable records are deposited after the voter has had an opportunity to verify that the record is an accurate representation of the voter's selections.

16. The voter verifiable voting system of claim 15 wherein
the vote casting unit records an electronic record of all votes cast.

17. The voter verifiable voting system of claim 11 wherein
the vote casting unit records an electronic tally of all votes cast for each voting choice.

18. The voter verifiable voting system of claim 16 wherein
the computing unit of the vote casting unit is a programmable computer using a Windows operating system, the input device for the vote casting unit is a numeric keypad, and the electronic record is stored in an encrypted file on removable optical media.
